(19) United States
(12) Patent Application Publication
(10) Pub. No.: US 2011/0169605 A1
(43) Pub. Date: Jul. 14, 2011

(54) SYSTEM AND METHOD FOR PROVIDING REMOTE INDICATION

(76) Inventor: Christopher John Gunn, Australian Capital Territory (AU)

(21) Appl. No.: 12/745,326

(22) PCT Filed: Dec. 1, 2008
(86) PCT No.: PCT/AU2008/001777

§ 371 Date: Mar. 28, 2011

(30) Foreign Application Priority Data
Nov. 29, 2007 (AU) 2007906523

(51) Int. Cl. G08B 5/22

(52) U.S. Cl. 340/8.1

(57) ABSTRACT

An apparatus for providing remove indication over a teleconference environment. The apparatus comprises a first location and a second location having a suitable furniture arrangement in each location to allow teleconferencing in multiple zones within each location. The apparatus has a remote indicator system arranged for an object to be marked, and tracked from a remote location in conjunction with a tactile glove arranged for a user in the first location to control and guide a user in a second location to operation procedures.

### TECHNICAL FIELD

The present invention relates to a system and method for providing remote indication and, particularly, but not exclusively, to a system and method for providing remote guidance of a person.

### BACKGROUND OF THE INVENTION

Systems for remote visual and audio communication, such as teleconference systems, are known. Such systems allow a reasonable level of communication between parties over remote distances.

Communication over such systems is by no means perfect. For applications where an expert may wish to guide a remotely located assistant to carry out a particular procedure, for example, such teleconference systems have many limitations.

For example, the area of tele-health is concerned with the remote delivery of health services. A specialist may be required to guide a remotely located assistant to carry out a health related task, such as examination of a patient at a location remote from the specialist. Present teleconferencing systems are limited in facilitating what may be a highly complex task. Communication is limited to video and audio. With these limitations it is very difficult for a specialist to correctly guide the assistant at the remote location.

### SUMMARY OF THE INVENTION

In accordance with a first aspect, the present invention provides a system for providing remote indication, comprising a projection arrangement arranged to project an indicator onto an object at a first location, and a control arrangement enabling control of projection of the indicator from a second location remote from the first location.

In an embodiment, the system is implemented together with video and audio communication links that enable teleconferencing to take place between the first and second locations. In an embodiment, an operator at the second location may utilise the control arrangement to control projection of the indicator as they are taking part in a teleconference over the communication link. The operator may therefore be able to guide an assistant at the first location, by way of the indicator, during the teleconference.

In an embodiment, the system further comprises a tracking arrangement, the tracking arrangement is arranged to control projection of the indicator to track motion of the object, whereby the indicator remains projected onto the object as the object moves. In an embodiment, the tracking arrangement is arranged to track the object automatically without requiring input from an operator at the first location.

In an embodiment, the control arrangement is arranged to control the projection arrangement such that the indicator projected is an artifact. The artefact may be an annotation, a drawing, a graphic, a pattern or any other artefact. In an embodiment, the artefact is two dimensional.

In an embodiment where the system is associated with a teleconferencing system, comprises the tracking arrangement and where the control arrangement controls the projector to produce an artefact, an operator at the second location may produce informative artefacts at the first location which are projected onto an object and which move with the object. An assistant at the first location may therefore be provided with comprehensive information that may be associated with the object. In one example application, the operator may be a medical specialist advising an assistant at the first location about examination of a patient also at the first location. Using the system, the medical specialist may be able to draw or otherwise annotate parts of the patient's anatomy to clearly illustrate an examination procedure or other information to the assistant at the first location. If the patient moves, then the tracking arrangement may operate to ensure that the indicator stays on the appropriate part of the patient's anatomy notwithstanding the motion of the patient.

In an embodiment, where the first and second locations are connected by a teleconferencing arrangement, the teleconferencing arrangement includes at least one camera at each location, at least one video display at each location, and a furniture arrangement at each location. In an embodiment, the furniture arrangement, the video camera and video display are arranged so that the first location appears as a complementary arrangement to the second location. In an embodiment, it may appear to a person viewing across the teleconference link at the second location that the person at the first location is sitting at a pre-determined position with respect to them. In an embodiment, the furniture may comprise a desk and it may appear that the person at the first location is sitting at a position at the desk with respect to the person at the second location. This may have the advantage of facilitating a remote consultation, such as a specialist advising an assistant at a remote location, more effectively.

In an embodiment, a remote actuator is provided at the first location which may be arranged to be mounted to or worn by a person at the remote location. An actuator controller is arranged to enable control of the remote actuator from the second location. In an embodiment, an operator at the second location may utilise the actuator controller to control the remote actuator at the first location to apply a stimulus to the person mounting or wearing the actuator. This may facilitate guidance of the person by the operator. In an embodiment, the remote actuator may be a vibro-tactile actuator which may provide a physical “nudge” or “tap” to the wearer. The vibro-tactile actuator or actuators may be mounted by a wrist band or a glove worn by the person.

In accordance with the second aspect, the present invention provides a method of providing a remote indication, comprising the steps of projecting an indicator onto an object at a first location, and controlling the projection of the indicator from a second location remote from the first location.

In an embodiment, the method comprises the further step of tracking motion of the object and controlling projection of the indicator to remain in position on the object during the motion.

In accordance with an embodiment, the step of projecting the indicator comprises a step of projecting an artefact. The artefact may be an annotation, drawing, pattern, animation, graphic or any artefact.

In accordance with a third aspect the present invention provides a teleconference system, comprising at least one video display and one camera at each of a first and second location, and a furniture arrangement provided at each of the first and second locations, the furniture arrangements, video cameras and video displays being arranged so that the first location appears as a complementary arrangement to the second location.

In accordance with a fourth aspect, the present invention provides a teleconference system, comprising at least one video display and one camera at first and second locations, a remote actuator at the first location and an actuator control arranged to enable control of the remote actuator from the second location.

In accordance with a fifth aspect, the present invention provides a method of teleconferencing between a first location and a second location, comprising the steps of arranging at least one video display, a camera and furniture at the first and second locations such that the first location appears as a complementary arrangement to the second location.

In accordance with a sixth aspect, the present invention provides a method of teleconferencing, comprising the step of controlling a remote actuator at a first location, from a second location, in order to guide an assistant at the second location.

### BRIEF DESCRIPTION OF THE DRAWINGS

Features and advantages of the present invention will become apparent from the following description of embodiments thereof, by way of example only, with reference to the accompanying drawings, in which;

FIG. 1 is a schematic diagram of a system in accordance with an embodiment of the present invention;

FIG. 2 is a diagram of a system in accordance with an embodiment of the present invention showing an example arrangement of furniture and system devices for creating a teleconferencing environment;

FIG. 3 is a diagram illustrating operation of an embodiment of the present invention;

FIG. 4 is a flow diagram illustrating a control process for controlling an embodiment of the present invention;

FIG. 5 is a block diagram illustrating an arrangement for controlling a remote actuator in accordance with an embodiment of the present invention;

FIG. 6 is a block diagram illustrating an arrangement for controlling a remote actuator in accordance with another embodiment;

FIGS. 7A-7C are diagrams illustrating the transformation of a captured image from a relative coordinate system to an absolute coordinate system in accordance with an embodiment of the present invention; and

FIGS. 8A and 8B are diagrams illustrating the calibration process of the projector and the camera in accordance with an embodiment of the present invention.

### DETAILED DESCRIPTION OF AN EMBODIMENT OF THE INVENTION

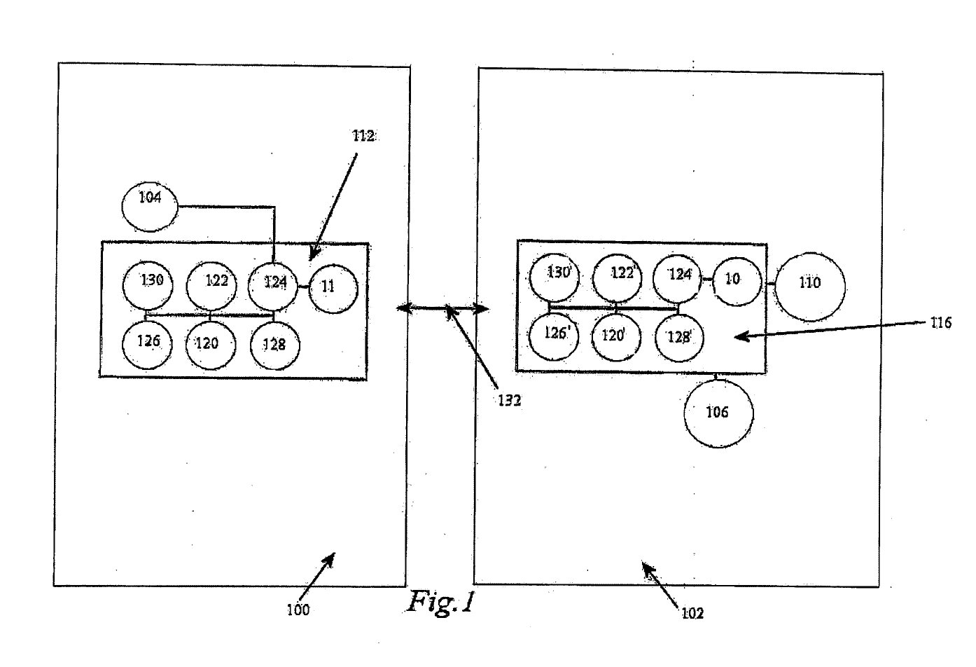

Referring to FIG. 1, an example embodiment of the present invention is arranged for operation between a first location 102 and second location 100 remote from the first location. The system of this embodiment comprises a projection arrangement 10 positioned at the first location 102 and in this embodiment comprising a laser projection apparatus 10, which will be described in more detail later. A computing system 124′ comprises part of a control arrangement for the projector 10. Another computing system 124 at the second remote location 100 comprises another part of the control arrangement for the projector 10. In this embodiment, a user interface device, such as a mouse 11 (or could be any other device, such as a pen for drawing on a touch sensitive screen) enables control of the projector 10 from the second location 100. The projector 10 is arranged to project an indicator on an object at the first location 102, and control of this indicator may be applied utilising the input device 11 and computing system 124 at the second location 100.

In this embodiment, the projector 10 and the control arrangement provided by computing system 124, 124′ and input device 11 can be used to apply deixis at the first location 102 under control of an operator 104 at the second remote location 100. The indicator may be projected onto a person or object at the first location 102. It may therefore be used during a teleconference between the locations 100 and 102 to provide deixis from the location 100 and therefore facilitate guidance of a person at the first location 102 by, for example, an expert 104 at the second location 100.

An embodiment of a system for providing remote indication which operates over a teleconference link will now be described in detail. As well as providing for deixis, this embodiment also provides an environment which gives a more integrated and interactive conferencing experience. This embodiment may be particularly useful for tele-health applications, although it is not limited to such applications.

A medical specialist 104 may deliver advice, facilitate examinations, diagnosis and other medical processes by guiding an assistant 110 at the first location 102.

Referring again to FIG. 1, in this example the second location 100 is a specialist's 104 office and the remote, first location 102 is a clinic room where a patient 106 is located together with a medical assistant 101, such as a nurse, for example.

At the second location 100, an observation system 112 is provided. The observation system includes a computing system 124 referred to above, and a arrangement of tele-communication devices and furniture for teleconferencing. At the first location 102, there is provided an operations system 116 which includes an arrangement of tele-communications devices and furniture for teleconferencing.

A communications link 132, which may be any communications link, such as the Internet, a dedicated tele-communications link or any other communications link, connects the observation system 112 and operation system 116.

In this embodiment, as well as the arrangement which enables remote deixis, the operation system 116 and observation system 112 comprise appropriate arrangements for implementing teleconferencing over the communications connection 132, including cameras 130, 130′, video screens 122, 122′, microphones 128, 128′, speakers 126, 126′ and appropriate systems control implemented by software/hardware of the computing systems 124, 124′.

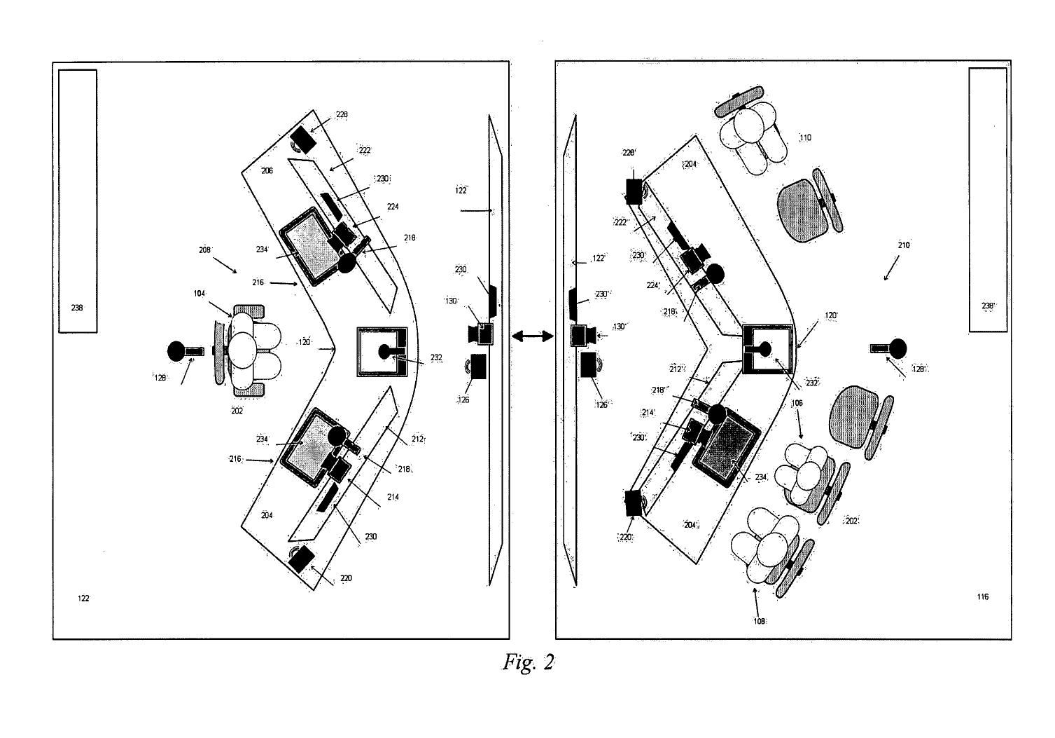

Referring to FIG. 2, an aspect of this embodiment is the arrangement of teleconference devices and furniture within the first and second locations, to create a complementary arrangement. In this embodiment, the arrangement is designed such that the work spaces provided at the first and second locations provide for a richer type of communication than afforded by typical teleconference systems. In particular, a variety of non-verbal communication behaviours, such as gaze, posture, gesture and proximity are catered for.

As shown in FIG. 2, the properties of the desks 120, 120′ in the specialist office and clinic room have perceptually similar surface geometry, such as having the shape of the top surfaces substantially similar. In this embodiment, each desk consists of two wings (204, 204′, 206, 206′), set at an angle. In this embodiment, the interior angle is between 90° and 120°.

The desk 120 at the second location is arranged such that the specialist 104 can sit comfortably in the interior, and is accompanied by a chair 202 that enables the specialist to easily swivel from one wing to the other, and roll backwards and forwards. The desk 120′ at the first location is arranged such that people can sit comfortably around the exterior, and has seating 202′ for several people on both wings.

In this example, one wing of each desk is nominated as the “consultation wing” 204, 204′ and the other as the “examination wing” 206, 206′, and these are reflected at the first and second locations, respectively, so that if, for example, the consultation wing 204 of the desk 120 at the second location is on the right when viewed by the specialist seated at the interior 208, then the consultation wing 204′ of the desk 120′ at the first location should be on the left when viewed by assistant 110 sitting at the exterior 210. Where possible, the consultation wing of the desk 120′ is chosen to be the one closest to the main entrance of the clinic room 102.

This arrangement, together with the placement of the teleconferencing equipment (described below) provides the effect of a single “virtual” desk, the two sides of which are shared respectively by the specialist 104, assistant 110 and patient 106.

The second location 100 is provided with main display 122 (which may be a wall-mounted projection system, LCD screen, Plasma screen, CRT screen, or other type of display) located anterior and above the desk 120. This is positioned such that the display 122 is centre and clearly visible to a specialist 104 seated opposite at the interior 208 of the desk. Similarly, the first location has a main display 122′ located anterior to and above the desk 120′. The desk 120′ is positioned such that the display is centred and clearly visible to an assistant 110 and patient 106 seated opposite the exterior 210 side of the desk.

The observation system 112 has a room camera 130 fitted with a wide-angled lens and positioned such that the camera 130 is pointing towards the desk 120 from the exterior side (for example, mounted in or above the main display 122). The arrangement of the lens angle, position, and orientation of the camera 130 is such that as much of the room 100 as possible is within the field of view of the camera 130, and in particular so that any person in a normal standing position or entering or leaving the room 100, can be captured. For example a lens angle of 100° would be typical. The operation system 116 has a room camera 130′, fitted with a wide-angled lens and positioned so that it is pointing towards the desk from the interior side (in this example being mounted in or above the main display). The arrangement of the lens angle, position and orientation of the camera 130 captures as much of the room 100 as possible, such that all the people in the room 100 can be seen. In some examples, the room camera 130 may be a series of individual cameras arranged to operate concurrently to capture the entire room 100.

Audiovisual capture and transmission hardware and/or software executing on computing systems 124, 124′ is used to ensure that the view from the room camera 130 in the observation system 112 is at all times displayed on the main display 122′ in the clinic room 102, and similarly that the view from the room camera 130′ in the operation system 116 is at all times displayed on the main display 122 in the observation system 112.

The observation system 112 has a microphone 128 located and directed so as to pick up sound from the general area of the room posterior to the desk 120 including the interior side of the desk 120 at and behind the seating position. The operation system 116 also has a speaker 126′, located and directed so that sound emerges from the direction of the display 122. Similarly in this embodiment, there is a microphone 128′ in the operation system 116 located and directed so as to pick up sound from the general area of the room in front of the desk 120′, including the exterior side of the desk 120 and behind the seating positions. There is a speaker 126′ in the operation system 112 located and directed so that sound emerges from the display 122′.

Sound detected by the microphone 128 in the observation system 112 is produced from the speaker 126′ in the operation system 116, and similarly, the sound detected by the microphone 128′ in the operation system 116 is played from the speaker 126′ in the observation system 112. Echo-cancelling techniques (hardware and/or software) may be used to reduce feedback and echoes.

The consultation wing 204 of the desk 120 of the observation system 112, mounts a consultation display 212 facing the seating position at the interior of the desk 208. There is also a consultation display 212′ in the operation system 116 mounted on the consultation wing of the desk 120′, but facing the seating positions at the exterior of the desk 120. The displays 212, 212′ are as large as practical, while being safely and comfortably viewable from the seating positions, and not obscuring any large portion of the main displays 122, 122′. The desired effect is that of a localised teleconferencing environment between the interior 208 of the desk 120 in the observation system 112 and the exterior 210 of the consultation wing of the desk 120′ in the clinic room.

The observation system 112 has a consultation video camera 214 located as close as possible to the centre of the consultation display 212, while not blocking the view of any significant portion of that display 212. The camera 214 may, for example, be mounted in a bracket at the top of the display 212. The camera 214 should be positioned and oriented to have a clear view of the seating area at the interior 208 of the desk 120. A consultation video camera 214′ of the operation system 116 is located as close as possible to the centre of the consultation display 212′, while not blocking the view of a significant portion of that display 212′. The camera 214′ is positioned and oriented to have a clear view of the seating area at the consultation wing side of the exterior 210 of the desk. The consultation camera 214′ in the operation system 116 is electronically controllable for pan/tilt/zoom. An interface 216 is provided by the observation system 112 so that the camera 214′ can be controlled remotely. The interface 216 provides a suitable user interface device for controlling the consultation camera 214′. In some examples, the interface 216 may have a joystick arranged to be electronically connected to a series of servos on the camera. Once the user manipulates the joystick, an electronic or electrical signal can then be transmitted to the camera to pan, tilt or zoom. In other examples, the interface 216 may be a tablet PC connected to the camera. The images captured by the camera 308 is displayed at least partially on the display screen of the tablet PC. In this example, the user can pan, tilt or zoom the camera by using a stylus, mouse or other input device to select the portion of the displayed image that the user desires to direct the camera to focus on. Once the user directs the camera to focus on a specific point on the image, the camera is then panned, tilted or zooned to focus on the specific point.

The observation system 112 has a consultation microphone 218 and consultation speaker 220 located close to the consultation display 212, arranged on the consultation wing 204. The microphone 218 is positioned and oriented to capture sound from the seating position at the interior of the desk 208 directed towards the consultation display 212, and the consultation speaker 220 is positioned and oriented so that sound emerges from the direction of the consultation display. The operation system 116 comprises a consultation microphone 218′ and consultation speaker 220′ located close to the consultation display 212′, so as to allow the consultation microphone 218′ to capture sound from the consultation wing of the exterior of the desk 120. Sound from the consultation speaker 220′ emerges from the direction of the consultation display 212′. In one example, separation between the microphone 218′ and speaker 220′ (typically>400 mm) facilitates echo cancelling.

The view by the consultation camera 214 in the observation system 112 is displayed by the consultation display 212′ in the clinic room 102. The transmission hardware/software also provides that the view by the consultation camera 214′ in the operation system 116 is displayed on the consultation display 212 in the observation system 112. Sound from the consultation microphone 218 in the observation system 112 is played on the consultation speaker 220′ in the clinic room; and sound from the consultation microphone 218′ in the operation system 116 is played on the consultation speaker 220 in the observation system 116. Echo-cancelling techniques (hardware and/or software) are used to reduce feedback and echoes from these and all other audio sources.

The observation system 112 and the operation system 116 have an examination display 222, 222′, examination video camera 224, 224′, examination microphone 226, 226′ and examination speaker 228′ arranged on the examination wing 204 of the desk 120 of the observation system 112 correspondingly with the examination wing 206′ of the desk 120′. These operate in a similar manner to the arrangement on consultation wing side 204, 204′.

Each of the cameras including the room camera 130, 130′, consultation camera 214, 214′ and examination camera 224, 224′ of both the observation system 112 and operation system 116 has a feedback display 230, 230′ located close to the camera (130, 130′, 214, 214′, 224, 224′) directly showing the output of that particular camera. The feedback displays 230, 230′ are positioned so that people in view of the cameras can see how they appear as captured by the camera. A variation is to have the display 230, 230′ show a left/right flipped version of the camera view, so that feedback appears like a mirror. The use of a feedback display allows the users in both rooms to confirm that the system is functioning to enable users to monitor their own appearance.

In either or both of the specialist's office 100 and the clinic room 102, provision may be made for observers to be seated behind or to the side of the main seating areas. The observer seating is clearly within view of the main cameras 130, 130′. There may be a large format display placed in the room so as to be clearly visible to people seated in the observer seating, without blocking access to the other displays (such as the main display). Further in the clinic room 102, additional displays can be provided for the patient, people accompanying the patient, and the clinical assistant.

In one embodiment, in either one or both of the observation system 112 and the operation system 116, a document camera 232, 232′ (also known as a document visualiser) can be located on the desk 120, 120′. The output of the document camera 232, 232′ can be captured and transmitted for display on any of the display screens both locally and remotely in the other room 100, 102.

In one embodiment, in the clinic room 102, the area in front of the examination wing of the desk 206, may be provided with additional video cameras and microphone, or other types of video and audio sources, suitable for conducting a specialist examination of the patient. The output of these devices should be captured and transmitted for display in the observation system 112. For example, various embodiments could include an intra-oral camera, an ultrasound scanner, a stereo pair of video cameras, a nasal endoscope, or an electronic stethoscope.

In embodiments where there is a need to show additional video sources or computer output, the needs can be met by providing additional displays. One embodiment has a horizontally oriented or tablet-style display 234 for the specialist located on or in the desk in front of and below each of the consultation wing display and examination wing display in the observation system 112. These displays should also function as computer input/output interfaces where needed. A preferred embodiment would use tracked stylus or touch-screen as an input mechanism on these interfaces. Other vertically or horizontally oriented displays could be added lateral to the consultation area display and examination area display as necessary.

This arrangement of the observation and operation systems 112, 116 located in two distantly remote locations, comprises a desk, audio/visual equipment arrangement which provides a sense of presences of the distant party. All participants utilising this arrangement have context awareness and a common frame of reference for their discussion and interaction. The arrangement provides gestures and physical guidance in the real world space as well as on computer displays. This common frame of reference is achieved through the appropriate arrangement and connection of multiple video cameras, displays, microphones and speakers as well as selection and arrangement furniture. This arrangement creates a complementary teleconferencing environment at both ends of the system that supports a remote clinical consultation more effectively than is usually achieved with current teleconferencing systems.

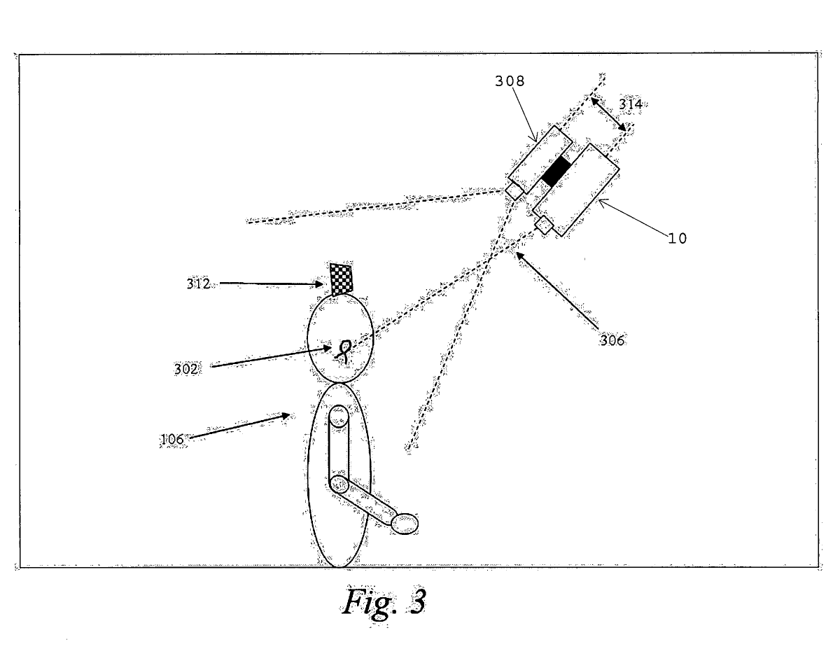

FIG. 3 is a schematic diagram illustrating the projection apparatus 10 and also part of the control arrangement, to illustrate operation of deixis in this embodiment. The projector 10 is a laser lightshow projector 100 with a shutter and twin galvanometers, in this example. The projector 10 is mounted on a rotatable servo and positioned for providing a range of electronic control movements in any horizontal and vertical angle. This range of movement allows the projector 10 to direct a beam of light to most parts of the room and thereby provide complete coverage of all patients, clinical staff, visitors and any medical equipment in the clinic room 102. The projector 10 emits a luminous indicator 302 which in one example is in the form of a dot or a pattern. In this example, the indicator 302 luminous indicator is sufficiently bright to enable detection in bright, normal and ambient lighting conditions at the first location 102. The indicator may by produced as a drawing (as shown in FIG. 3), a pattern, an animation, a annotation or essentially any artefact. It may be produced as an annotation giving information, for example. The indicator may be projected on any person or object at the first location 102.

The projector is linked with computer system 124′ and a projector controller includes a control software module 400. The projector control software module 400 is linked to the observation system 112 enabling the specialist 104 to control the projector 10. The input device 11 allows input signals to be entered by the specialist 104 for control of the projector. These signals are transmitted via the specialist's computing system 124 and the network connection 132 to the clinic room's computing system 124. The specialist 104 is able to direct the movement of the projector 10 as well as the intensity of the beam 306. The specialist 104 is able to manipulate the input device to create annotations, drawings, patterns or any other artefact. For example, input device 11 may be a mouse or pen interacting with a graphic user interface enabling the specialist to create artefacts via the graphical user interface which are reproduced as the indicator 302 by the computing system 124, 124′ and projector control software module 400. In order to facilitate control of the projector 10, the specialist 104 is able to view via the display 122, the output of camera 130 which will capture and transmit an image of the clinic room 102.

In this embodiment, the projector 10 is fixed to a tracking camera 308 adapted for capturing and tracking the position of the luminous indicator 302. The camera 308 is moved with the projector 10 when the projector is manipulated and is capable of producing a video stream that can be sent across the network 132. The camera 308 is also controlled by a camera controller routine 402 which receives commands from the observation system 112 to focus, zoom, and control the image on the camera. The routine 402 can also supply information about the camera field of view and subject range to the computer 124′ along with a video stream which is transmitted to the computer 124′ in the operation system 116. The video stream is processed by a mark tracking software module 404 executing on the computer 124′.

The specialist 104 monitors the output of the video stream from the tracking camera on a display associated with the computing system 124′ and then may use the input device 11 to manipulate a GUI to indicate and mark objects at the clinic room 102.

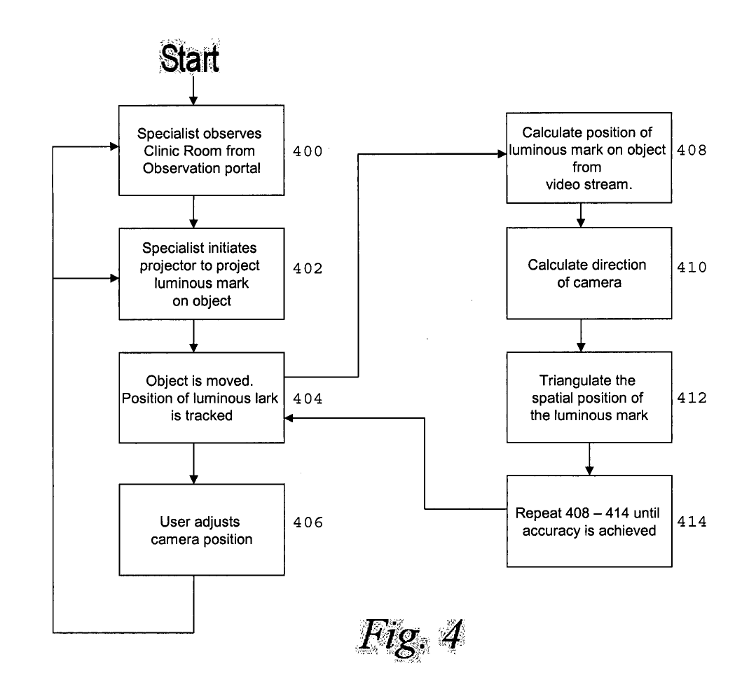

Projector control software is executed by the computer 124′ and is arranged to signal the servos to operate to aim the projector 10 at its subject. Further commands may be issued to control the intensity and shape of the indicator 302. The projector control software communicates directly with the specialist's computer 124 in the specialist's office 100 via a network connection 132 such that the specialist's computer 124 is able to transmit control signals to the projector 10. The projector control software may instruct the laser projector 10 to produce any artefact or graphic for display. Once the artefact or graphic is displayed, the software then translates the image captured by the camera from a camera coordinate system to a projector coordinate system by using the view information supplied by the camera controller routine as shown in FIG. 4 (408-414).

A camera controller routine receives commands to move, zoom and control the image captured by the camera 308 then instructs the camera 308 to perform these actions. The routine also supplies information about the current camera 308 field of view and subject range to other components, this information is then presented to the specialist interface which displays the video stream from the camera 400. The specialist 104 can then draw on the video stream by using the input device directly on the display.

The projector 10 accommodates movement of each person or object. If a person moves, the indicator is effectively ‘tracked” to their body and will move with them.

The tracking module instructs the laser projector 10 to redraw the indicator on a new position to follow the moving patient 304 or object. This is done by translating graphics 400 captured in the camera 308 from a camera coordinate system to the projector coordinate system by using the field of view information supplied by the camera controller routine (408-414). This module is implemented using image based tracking techniques, such as, but not limited to, ARToolkit, a software library for building Augmented Reality (AR) applications (http://www.hitl.washington.edu/artoolkit/). A fiducial marker 312 is attached to the patient's head, body or limb, or in the case of an object, any portion of the object. The camera 400 captures the image of this marker 312 and the module identifies this fiducial marker 312 and tracks both its location and orientation in space by recognising the size and shape of the pattern in the fiducial marker 312. As the module has a record of the spatial location of the most recent luminescent indicator 302 relative to the fiducial marker 312. It moves this luminous indicator 302 appropriately with any subsequent movement in the fiducial marker 312, caused by the patient or object moving. This is done by the following steps:

1. The projector 10 is fixed and, therefore, the direction of the projected beam 306 (e.g. laser beam) is known for a specific piece of the luminous indicator 302. (408)

2. The position of the luminous indicator 302 within the image captured by the camera 308 can be calculated by locating the known laser colour in the pixels of the image and building a model of the (known) luminous indicator 302. (410)

3. Once the position of the luminous indicator 302 has been calculated, the direction of the indicator 302 from the camera 308 is then revealed. (412)

4. Since the camera 308 is at a known displacement 314 from the projector 10, it is then possible to triangulate in two directions and calculate the spatial position at the intersection of the two directions. (414)

5. This process can be repeated for several positions on the luminous indicator 302 to build a more accurate estimate of the surface that the laser 306 is projected onto.

Because the 3D location of the luminous indicator 302 is known relative to the 3D location of the fiducial marker 312, the luminous indicator can be appropriately moved to match any translations and rotations of the fiducial marker 312. Since the fiducial marker 312 is attached to the patient's body, the luminous indicator 302 will move correctly with rotations and translations of that part of their body

If the object 106 is rotating the fiducial marker 312 attached to the object 106 may also rotate and may appear to change shape when viewed from the camera 308. Once the tracking module detects this rotation by monitoring the changes to the fiducial marker 312, the module may then direct the projector 10 to change the shape of the indicator 302, resulting in the indicator 302 to change shape to accord with the rotation of the object.

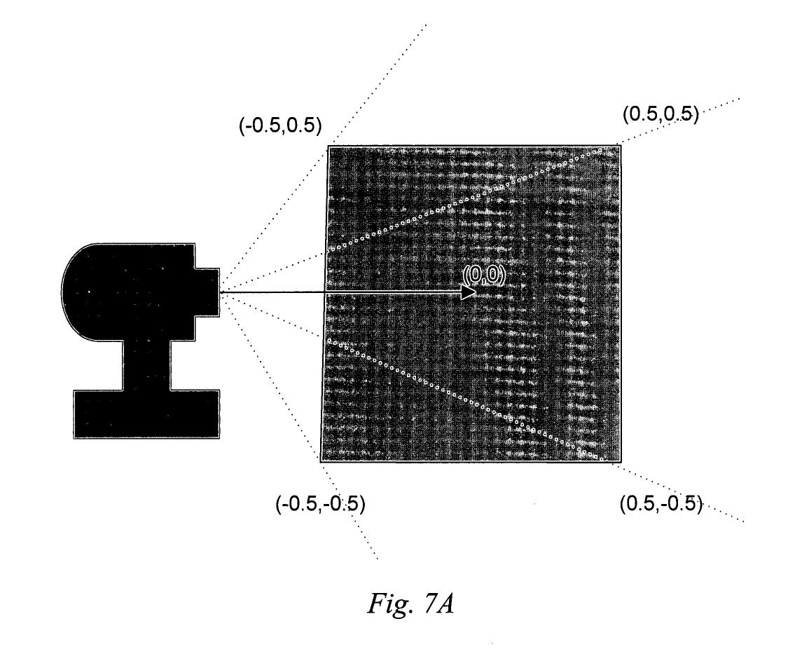

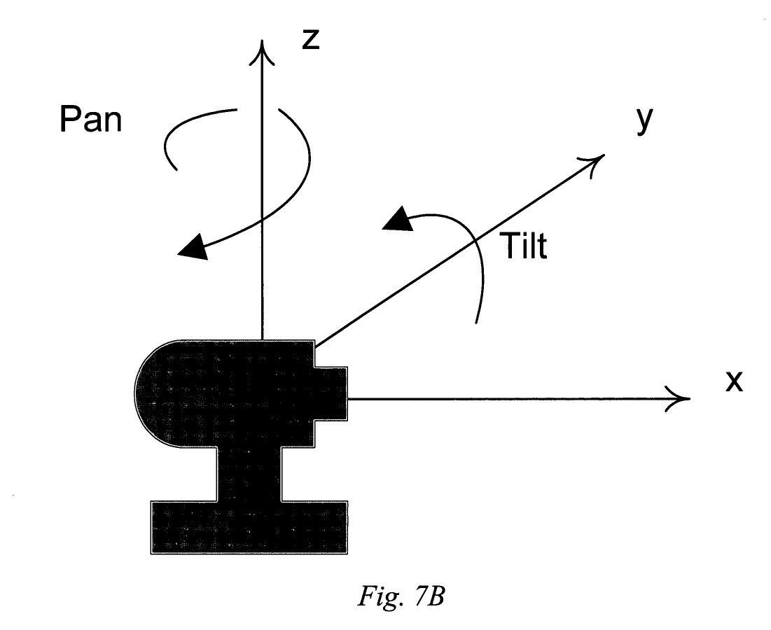

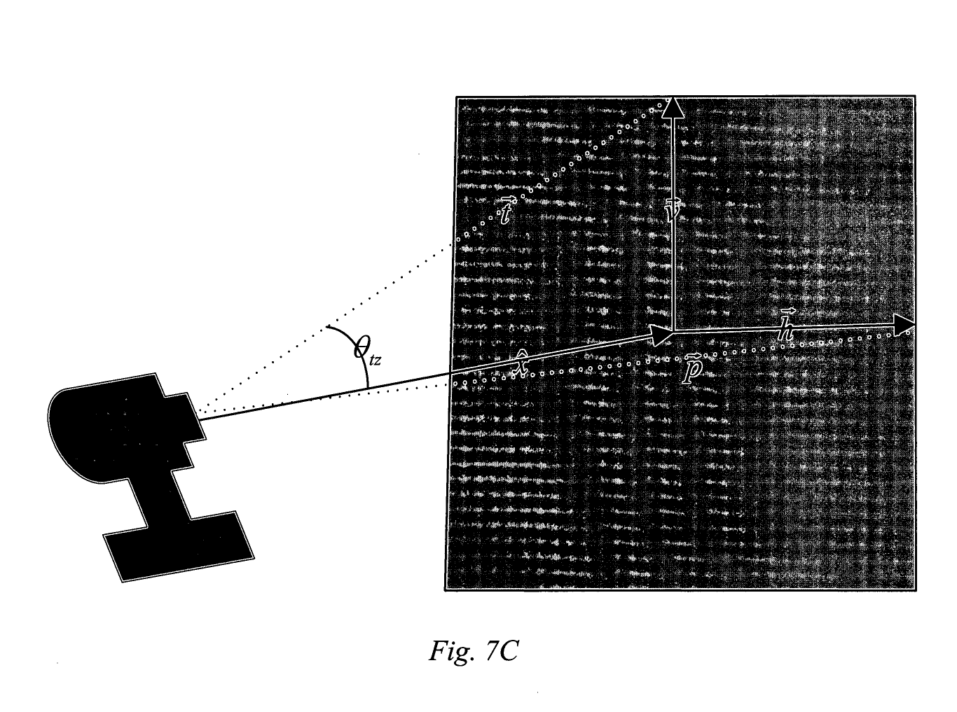

Although there are many different methods of implementing the tracking module, to calculate the position of the luminous indicator, 302, an example implementation of the tracking module for calculating the position of the luminous indicator 302 is shown in FIGS. 7A-7C. Once the camera 308 captures an image with the luminous indicator 302, the module maps the images to an image map using a relative coordinate system native to each camera 308 in order to provide a coordinate reference to every pixel of the captured image. Once this is done, the module then transforms the map to an absolute coordinate system to determine the position of the luminous indicator 302 within the image captured and thereby providing an uniform coordinate for the camera 308 and the projector 10 to locate the indicator 302, and thereby allowing the indicator 302 to be tracked and controlled by the tracking module.

The relative coordinate system, as shown in FIG. 7A is a coordinate system which maps the current view of the camera 308 into a pair of coordinates. This system is based on the angle of view of an individual camera 308 and therefore, once a luminous indicator 302 is tracked by its color on a captured image, the indicator 302 will have a coordinate to mark its position on the image. This relative coordinate system is modeled on an assumption that a virtual plane is in front of an individual camera 308, with the indicator 302 located at a known position, such as the centre of this plane along the camera direction. The centre is assigned a relative coordinate (0,0) and each corner of the image is assigned a coordinates to define a field of view of the camera 308 for example, (−0.5, 0.5), (0.5, 0.5), (−0.5, −0.5) and (0.5, −0.5). In this example, the lens distortion of the image is ignored, although relative distortion known for a specific camera model can be factored into the assignment of each coordinate. In circumstances where there are multiple cameras 308, each camera will have its own relative coordinate system.

In this embodiment, each camera 308 is capable of movement, such as zoom, pan and tilt. To accommodate for this range of movement, the relative coordinates are assigned with reference to the current direction of the camera 308, which accordingly, when the camera is moved (pan, tilt or zoomed) the angle of view will change, and in order to maintain the known position of the luminous indicator 302, the angle of view is recalculated by the tracking module. This is done by utilizing a geometric transformation which allows relative coordinates to be translated into a pan and tilt for the camera 308 and for general direction finding. The equation for the angle of view is

$${θ}_{z} = 2 {tan}^{- 1} ( tan \frac{θ}{2 z} )$$

Where θ is the un-zoomed angle of view of the camera, z is the zoom level (ie. 1×, 2×, etc.) and θ_{z} is the zoomed visible angle.

Relative coordinates can then be converted into pan-then-tilt directions by

$$p = {tan}^{- 1} ( 2 x tan \frac{{θ}_{zp}}{2} )$$

$$t = {tan}^{- 1} ( 2 y tan \frac{{θ}_{zp}}{2} cos p )$$

Where x and y are the relative coordinates, p and t are the pan and tilt angles and θ_{zp} and θ_{zt} are the appropriately zoomed angles of view. The factor of cos p is a consequence of performing the pan before the tilt; for hardware with other conventions or operations, the order of calculation may need to be reversed.

Once the captured image with the indicator 302 has been mapped onto the relative coordinate system, the module then proceeds to transform this image map to be mapped onto an absolute coordinate system. The absolute coordinate system is based on vectors from a common origin and therefore, once the image map has been transformed to this system, the user interface for controlling the projected beam 306 does not need to be concerned with the geometry of the camera 308 or projector 10. This is due to the implementation of the absolute coordinate system in having a common origin with the camera 308, (or cameras) and the projector 10. This common coordinate system then allows the user to work with multiple camera views as all the camera views can have a uniform coordinate system with the projector 10 to position the indicator 302, leaving the conversion of absolute coordinates to relative coordinates for each camera with the individual camera controller.

In this embodiment, the transformation of the image map from the relative coordinate system to the absolute coordinate system is firstly done by converting each relative direction to each absolute direction of the luminous indicator 302 relative to the camera 308. The tracking module proceeds to compute the pan and tilt basis vectors that can be used to turn the relative coordinates into a direction. For example, if the camera is pointing along the x-axis, a pan represents a negative rotation about the z-axis and a tilt represents a negative rotation about the y-axis (assuming a right-handed coordinate system). This convention is shown in FIG. 7B.

The basis vectors can then be computed by treating the angles of view as rotations about the z- and y-axes and then projecting the results onto a plane at unit distance along the x-axis, as shown in FIG. 7C. With reference to FIG. 7C, if T(\vec{η},θ) is the transformation representing a rotation of a vector at angle of θ about an axis \vec{η} and \hat{x},ŷ,\hat{z} are the unit vectors along the x-, y- and z-axes respectively, then

$$\tilde{p} = T ( \hat{z} , {θ}_{zp} ) \hat{x} , \vec{h} = \vec{p} - \hat{x} = \frac{\tilde{p}}{\tilde{p} \cdot \hat{x}} - \hat{x} = \frac{\tilde{p}}{cos {θ}_{zp}} - \hat{x}$$

$$\tilde{t} = T ( \hat{y} , {θ}_{zt} ) \hat{x} , \vec{v} = \vec{t} - \hat{x} = \frac{\tilde{t}}{\tilde{t} \cdot \hat{x}} - \hat{x} = \frac{\tilde{t}}{cos {θ}_{zt}} - \hat{x}$$

From there, the position of a relative vector along the x-axis can be calculated as \vec{r}=\hat{x}+x\vec{h}+y\vec{v} and the actual direction is \vec{d}=T(\hat{x},ã)\vec{r} where T(\tilde{s},\tilde{t}) is a rotation transformation from \tilde{s} to \tilde{t} and ã is the direction of the centre of the view. The transformations T(\vec{v},θ) and T(\tilde{s},\tilde{t}) are standard transformation matrices. These matrices can thereby be utilised to determine the position of the luminous indicator 302 on the captured image referenced by the absolute coordinate system.

In an alternative embodiment, the tracking module is programmed to allow for situations where the camera and projector may not be perfectly co-located. In circumstances where the arrangement or dimension of the teleconferencing room does not allow the camera to be installed at a desirable position, and therefore may be installed in an initial position where the distance relative to the projector may not be uniform or known. The tracking module may be programmed with an additional step to calibrate the camera 308 with the projector. By calibrating the camera 308 with the projector, the module may identify the position of the camera relative to the projector, and thereby allow images mapped on the relative coordinate to be transformed to an absolute coordinate system. In order to calibrate the camera 308 with the projector, the projector firstly projects a series of beams or rays on to a target plane. These rays form at least one intersection on the target plane, and can be visually observed by a user running the calibration process (in some examples, the rays form a cross to mark the intersection). The camera 308 will then capture this image with the intersections and the user can then mark the intersections on the captured image on the interface 316, and thereby identifying the positions of the target plane relative to the captured imaged. These positions can then be used to calculate the displacement between the projector 10 and the camera 308. In order to ascertain the positions of the target plane, both the intersection points and the direction of these points (normal) must be calculated.

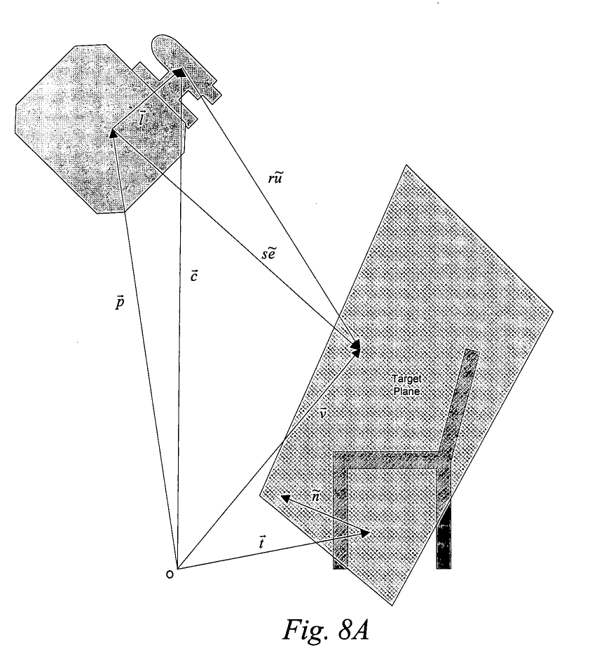

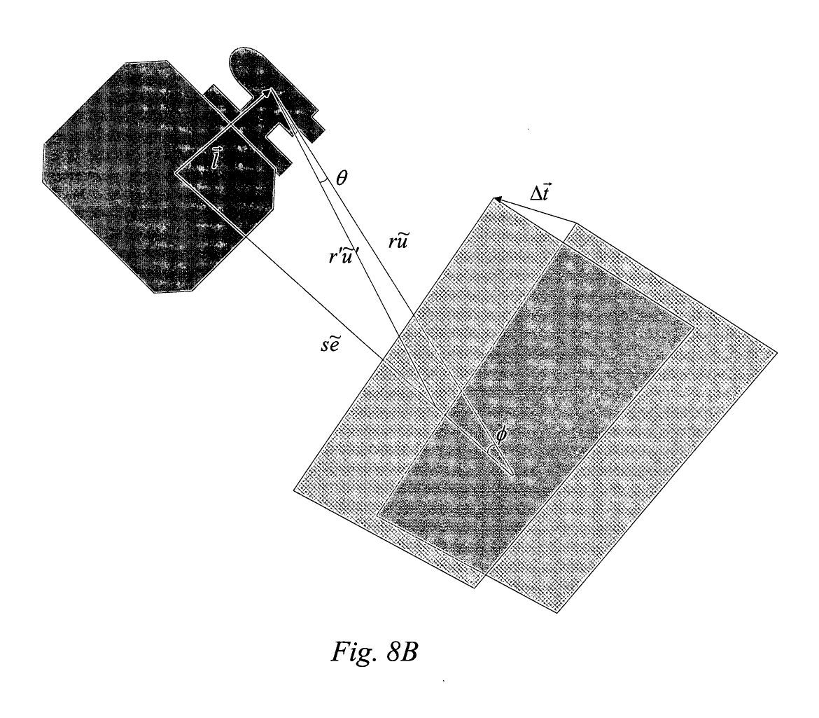

With reference to FIG. 8A, an example of the calibration step is provided in the form of a diagram. According to this example implementation, the module does not attempt to ascertain an exact model of the object to be drawn on, but rather uses a simple target plane, specified by the position and normal pair of (\vec{t},ñ). The desired target plane is currently specified in the system configuration. In FIG. 8A, O represents a common origin for position vectors. The camera, at \vec{c}, has a ray drawn in the direction of ũ to the point where it intersects the target plane at \vec{v}=\vec{c}+rũ Since \vec{v} is on the target plane, (\vec{v}−\vec{t})·ñ=0 and, therefore,

$$r = \frac{( \vec{t} - \vec{c} ) \cdot \tilde{n}}{\tilde{u} \cdot \tilde{n}}$$

The direction \tilde{e} from the projector, located at \vec{p}, is then given by s\tilde{e}=\vec{l}+rũ where \vec{l}=\vec{c}−\vec{p}

In examples where the actual display plane for the laser beam is not the configured target plane, then the output will appear to be shifted in the camera view. It is possible to model the effect of these errors by a shift in the target plane.

The effect of a shift is outlined in 8B. A shift of Δ\vec{t} in the target plane produces an apparent change in distance and direction from the camera to r‘ũ’ at an angle of θ from the original ũ. The sine and cosine rules give sin θ/(Δ\vec{t}·\tilde{e})=sin φ/r′, cos φ=\tilde{e}·\tilde{e} and r′²=r²+(Δ\vec{t}·\tilde{e})²−2r(Δ\vec{t}·\tilde{e})(ũ·\tilde{e}) Setting ρ=(Δ\vec{t}·\tilde{e})/r gives an equation for θ of

$${sin}^{2} θ = \frac{{ρ}^{2} ( 1 - {( \tilde{u} \cdot \tilde{e} )}^{2} )}{1 + {ρ}^{2} - 2 ρ ( \tilde{u} \cdot \tilde{e} )}$$

$$If s \approx r then ( \tilde{u} \cdot \tilde{e} ) \approx 1 - {l}^{2} / 2 {r}^{2} .$$

In one example of installation, the camera 308 has the following parameters, l is 12 cm and r is approximately 1 m. A 10 cm change in target plane will produce a change in angle of less than 1 degree−less than 2 cm at 1 m range. For other smaller cameras, 1 and r are approximately 1 m and a 10 cm change in the target plane will produce a change in angle of approximately 5 degrees.

In accordance with one example of the calibration procedure, a set of reference directions is chosen by the user and icons representing those directions are projected. The user can then click on the positions that the icons appear on the display. These positions are then sent incrementally, as relative positions to the projector. The projector can then calculate the closest point of intersection between the various reference directions and the transmitted position.

The closest point to intersection of two rays is the line that is perpendicular to both rays. The shortest distance between the two rays is given by

\tilde{e}·(\vec{l}+rũ−s\tilde{e})=0

ũ·(\vec{l}+rũ−s\tilde{e})=0

which has a solution of

$$r = \frac{1}{1 - {σ}^{2}} ( \tilde{u} \cdot \vec{l} - σ \tilde{e} \cdot \vec{l} )$$

$$s = \frac{1}{1 - {σ}^{2}} ( σ \tilde{u} \cdot \vec{l} - \tilde{e} \cdot \vec{l} )$$

$$where σ = \tilde{e} \cdot \tilde{u} .$$

To choose the corresponding reference direction, all reference directions are compared against the incoming camera direction and the intersection with the least error is chosen.

To find the “best” plane that fits the resulting collection of intersection points, {\vec{w}ᵢ=(xᵢ,yᵢ,zᵢ),i=1 . . . N}, the orthogonal distance regression plane is calculated.

This plane gives the minimum least-squares distance between the plane and the intersection points.

The plane point is the centroid of the point collection:

$$\vec{t} = ( {x}_{0} , {y}_{0} , {z}_{0} ) = \frac{1}{N} \sum {\vec{w}}_{i}$$

The normal is calculated by computing the covariance matrix of the intersection points:

$$A = ( \begin{matrix}\sum {( {x}_{i} - {x}_{0} )}^{2} & \sum ( {x}_{i} - {x}_{0} ) ( {y}_{i} - {y}_{0} ) & \sum ( {x}_{i} - {x}_{0} ) ( {z}_{i} - {z}_{0} ) \\ \sum ( {x}_{i} - {x}_{0} ) ( {y}_{i} - {y}_{0} ) & \sum {( {y}_{i} - {y}_{0} )}^{2} & \sum ( {y}_{i} - {y}_{0} ) ( {z}_{i} - {z}_{0} ) \\ \sum ( {x}_{i} - {x}_{0} ) ( {z}_{i} - {z}_{0} ) & \sum ( {y}_{i} - {y}_{0} ) ( {z}_{i} - {z}_{0} ) & \sum {( {z}_{i} - {z}_{0} )}^{2}\end{matrix} )$$

The eigenvector of A that has the least eigenvalue will equal to the normal ñ. In this example, the JAMA Java matrix package (see http://math.nist.gov/javanumerics/jama/) can be used to calculate the eigenvector. Once the module calculates the eigenvector, the normal or direction of the target plane can be ascertained. Once the normal is known, and in conjunction with the known intersection points selected by the user, the displacement between the camera 308 and the projector 10 is known, thus providing sufficient data for the location of the indicator 302 on the coordinate system.

This embodiment of the system is able to further enhance the ability of communication within a teleconference environment by allowing objects to be marked out whilst allowing each object to be tracked as it moves freely within the teleconferencing environment. This reduces the complexity in providing in voice commands alone. In this embodiment, the specialist needs only to use the projector to mark out specific areas or portions of objects without having to laboriously describe the location and appearance of the object by voice. Standard teleconferencing technologies do not allow deixis. Although remote pointers have been used before, these pointers only provide a simple spot of light. By using a “laser lightshow” projection system with the ability to track a moving object, complex artefacts can be remotely drawn onto a subject, giving a superior mode of indication. Where the person or object the indicator is drawn on moves, the indicator 302 remains on the person or object, allowing for free movement of the person or object.

In other embodiments, a standard projector can be used instead of a laser projector 10 by connecting a video projector to a video card. Most of the standard projector field displays black, with the indicator 302 appearing where non-black is shown by the projector 10.

If a drawing has a specified output size and range information from the projector 10 to the subject is available, then the projected image can be scaled to show at the correct size, within the accuracy of the ranging information.

In an embodiment, a stereo camera may be used to gain camera-subject depth information. This may then be used to provide a more accurate rendering of shapes and patterns across depth discontinuities.

In a further embodiment of the system, there is provided a tactile actuator 500 which provides a means for the specialist 104 to guide the assistant's hand, whilst leaving overall control with the assistant 110. This is achieved by providing tactile hints to the assistant, such as a controlled light tap on the skin of the assistant's hand.

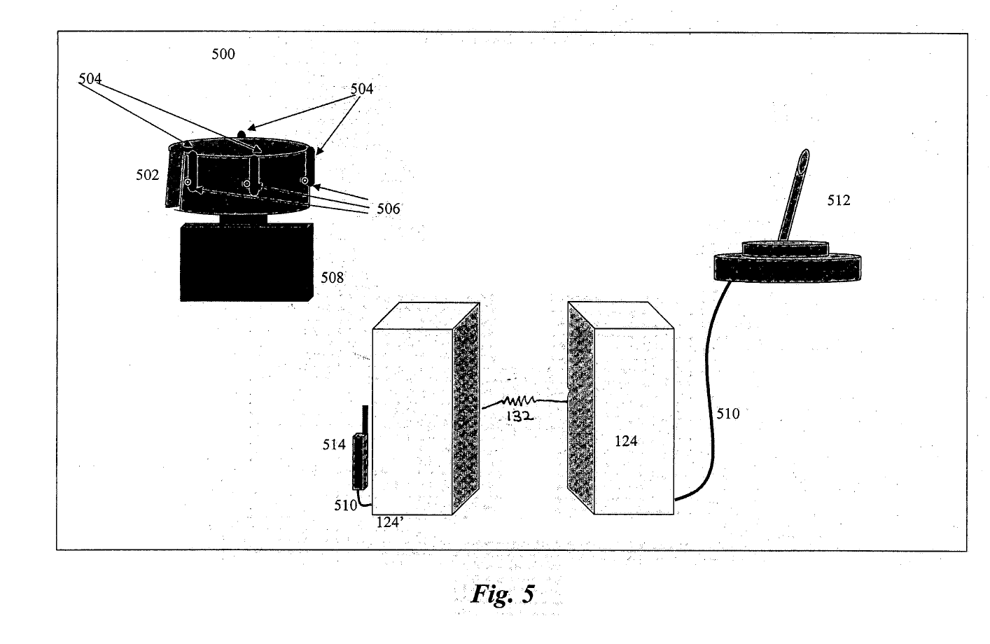

Referring to FIG. 5, in one embodiment the tactile actuator 500 comprises a wristband 502 that is worn by the assistant 110 in the clinic room 102 and includes an elastic wristband 502 that has a plurality of miniature 3V vibrating motors 504 (such as Jameco 256090PS) (sewn into pockets on four or more sides.) The shaft of each of these motors is enclosed in a plastic cap to prevent any moving parts contacting the wristband 502 itself.

Optionally, a miniature light globe 506 is attached to each motor. The light globe 506 is wired in parallel with the motor. The motors and connections are detachable to allow the wristband 502 to be washed. The wires are kept in place by Velcro or miniature studs, whilst the motors are wired to a controller chip mounted within a box 508 also attached to the wristband 502.

In one form the box 508 also contains a radio receiver. The receiver, control circuitry and motors are powered with two lithium coin cell 3V batteries (such as CR2450) although other power sources can be used. When the receiver detects an incoming radio message, it decodes the message and activates or deactivates one or more of the motors 504. In this form a radio transmitter 514 is connected to a computer 124′. The radio transmitter 514 sends commands to the radio receiver 508 to control the motors 504. The radio transmitter 514 is connected to the computer 124′ via a USB 510 connection. In another form, the box 508 is connected to the computer 124′ via a USB 510 or serial bus connection.

The tactile actuator 500 can be controlled by the means of a peripheral device 512, such as, but not limited to a joystick or mouse 512 located at the observation system 112. The specialist 104 can then use the joystick or switches 514 from the observation system 112 to control the actions of the assistant wearing the wristband in the clinic room 102. In this embodiment, the joystick 512 is connected to the computer 124 in the observation system 112 and upon manipulation, the translational and rotational inputs from this device are sent across a network to the computer 124′ within the operation system 116 for the purpose of providing the appropriate translational and rotational hints on the assistant's wrist-band 502, this is processed by a tactile hand control software which is executed on the computer 124, 124′ in both the specialist 104 and clinic rooms 102.

The software on the computer 124 within the observation system 112 initialises by connecting to the computer 124′ within the operation system 116. When the computer 124 receives a signal from the joystick 512, it checks if it is above a certain threshold and transmits the direction and magnitude of the joystick 512 manipulation to the computer 124′ within the operation system 116.

The software on the computer 124 within the operation system 112 then initialises by listening for connections from the computer 124 within the observation system 112. When a signal arrives, indicating that a joystick 512 has been manipulated, it converts the message into a repeating series of on/off pulses to one or more of the vibrating motors. The frequency of the pulses is proportional to the magnitude of the joystick 512 action that has occurred. The signals to the motors 504 are sent to a radio transmitter, which transmits the signals via a USB connection 510. These signals are then sent to the tactile actuator 500 to switch vibrating motors 504 on as well as off, as necessary.

The tactile actuator 500 provides additional physical guidance to the assistant 110 by allowing the specialist 104 to actively participate in the procedure or task the assistant 110 is required to perform. As there is constant physical feedback from the apparatus, the assistant 110 is able to correctly perform the procedure whilst experiencing detailed feedback from the specialist 104 that would not be possible on visual and audio guidance alone.

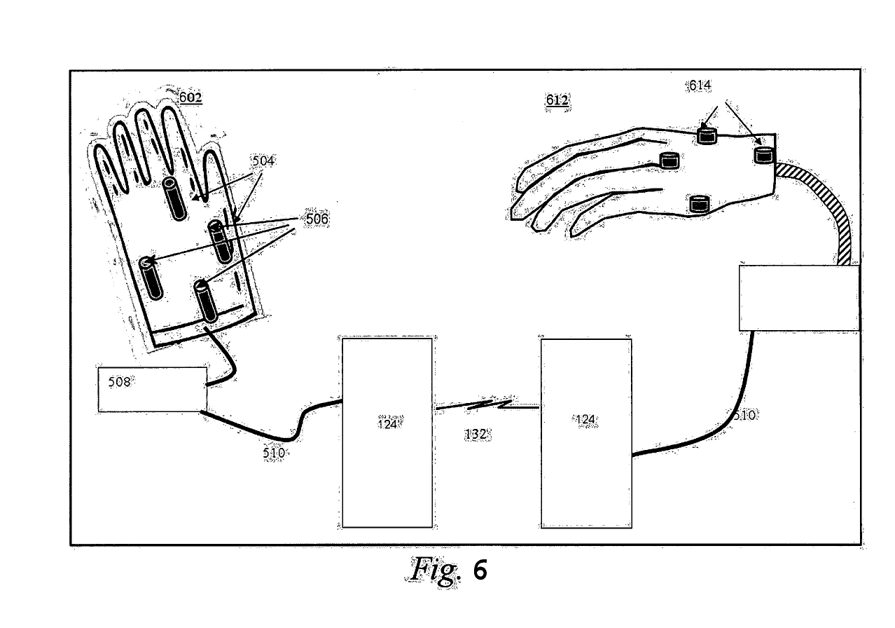

Referring to FIG. 6, a further embodiment of a tactile actuator will now be described. In FIG. 6, the same reference numerals as used in FIG. 5 have been used to denote the same components. No further description of these components will be given. In this embodiment, the tactile actuator 500 comprises a glove 602 that is worn by the assistant 110 in the clinic room 102. The glove 602 has a plurality of miniature 3 volt vibrating motors 504 sown into pockets around the central knuckle and palm position of the glove 602. The shaft of each of these motors is enclosed in a plastic cap to prevent any moving parts contacting the glove 602 itself. Optional miniature light globes 506 are attached to each motor 504 and are wired in the same manner as described in the embodiment of FIG. 5.

The glove 602 can be controlled by any peripheral device 612 such as described with reference to FIG. 5. In this implementation, however, a mannequin hand 612 is located at the observation system 112. The mannequin hand 612 includes a plurality of switches 614 placed in equivalent positions to the vibrating motors 504 on the glove 602. The specialist 104 uses the mannequin hand 614 (by wearing it), motions of the mannequin hand actuating the switches 614 to control the actions of the assistant via the glove 602 in the clinic room 102. In this embodiment the mannequin hand 612 is connected to the computer 124 in the same manner as described in the embodiment illustrated with reference to FIG. 5.

Another example embodiment of a tactile actuator 500, is a forearm sleeve arranged to be worn on the forearm of the assistant 110. The forearm sleeve has a plurality of motors 504 sewn into portions of the sleeve near the elbow and wrist of the assistant 110. The sleeve can be connected to the box 508 and can be used in conjunction with either the wrist-band 502 or glove 602 simultaneously. The forearm sleeve allows rotational advice as well as translational advice to be transmitted to the assistant 110.

### EXAMPLE

In using the system, a communications connection is set up between the two rooms, 100, 102 by system operators before the users enter the rooms. A specialist 104 enters the specialist office 100 whilst the clinic office 107 is populated with the assistant 110 and the patient 106. Once it is established that all the parties are within their corresponding rooms, a communications connection is made between the two rooms 100, 102. The specialist 104 can look into the overview display 122 and observe the assistant 110, the patient 106 and any visitor by visually inspecting the video images captured from the clinic office 102. Simultaneously, the parties in the clinic office 102 may also observe the specialist 104 by visually inspecting the video captured from the observation system 112. When the patient sits in the consultation chair 303 the specialist can direct closer conversation to the patient through the face-to-face camera/screen/speaker 212 and 212′ in their respective rooms. The specialist can alternatively turn their head to converse with the assistant through the alternative face-to-face camera/screen/speaker 222 and 222′. With this arrangement all participants are fully aware of the specialist direction of attention.

The parties in their corresponding locations can verbally communicate through the arrangement of microphones 128, 128′ and speakers 126, 126′ in both rooms 100, 102. The specialist 104 can direct the patient 110 to move towards the examination wing 206′ of the desk 120′. As the arrangement of the desks 120, 120′ and telecommunication equipment replicates a comparable environment by deliberately positioning the specialist 104, patient 106 and assistant 110 in such a way as to simulate a common spatial environment, and thereby providing spatial coherency between the two locations.

Upon inspection of a patient 106, the specialist 104 can utilise the projector 10 in the clinic room 102 and control its position and intensity with the input device 11. By observing any suitable display, the specialist 104 can direct the projector 10 over the patient 106 whilst controlling the intensity and thereby mark out certain areas or features of the patient with an indicator 302. The assistant 110 may move the patient 106 into a new position for inspection or move the patient 106 to a position captured by the examination camera 224′. The specialist 104 can begin guiding the assistant 104 to examine further through verbal instructions or referencing to specific luminous indicators 302 projected by the projector 10. The specialist 104 can use the microphone 128, to direct the patient 106 to be turned around for examination of another portion of the patient. Whilst the patient 106 is turned, the projector 10 continues to project an image onto the marked out areas of the patient 106 by tracking the position of the indicator made and the location of the fiducial marker 312. This allows both the assistant 110 and the specialist 104 to keep track of previously marked portions of the patient 106. In instances where more than one indicator 302 is desirable, a second and visually distinctive fiducial marker 312 can be placed on a second object or person. This allows the tracking module to track each indicator 302 separately by associating each indicator 302 to each distinct fiducial marker 312.

The specialist 104 may wish to direct the assistant 110 to specific equipment to execute a complicated procedure on the patient, such as a surgical procedure. The specialist 104 being in constant communication with the assistant 110 can clarify his or her position by guiding the assistant 110 through a plurality of indicators 302 made with the projector 10, which in one example is for marking out incision points on the patient 106. The specialist 104 may also control the camera 400 by zooming in onto certain detail in the room 102, including portions of incisions points of the patient 106.

The assistant 110 puts on the tactile actuator 500 which in one example is in the form of a wrist-band 502, before executing the procedure on the patient 106. The wrist-band 502 is connected via a USB connection to the computer in the operation system 116 whilst the specialist 104 can hold onto the joystick 512 connected to the computer in the observation system 112. The specialist 104, using the joystick 512, can activate at least one vibrator 504 on the tactile actuator 500 and thus guide the assistant 110 to better perform the procedure. Once the assistant 110 begins the procedure on the patient 106, the specialist 104 can observe the results on a display. If it is deemed necessary that the assistant 110 requires additional assistance, the specialist 104 can control the tactile actuator 500 to correct, confirm and guide the assistant's technique, whilst using the projector 10 to mark out new points and to verbally communicate with the assistant 106.

In the above embodiments, a tactile actuator arrangement is implemented within a wrist-band or glove. The invention is not limited to this. Tactile actuators may be mounted by other items of clothing or on other parts of the body.

In the above embodiments, the teleconferencing takes places across two locations. The invention is not limited to two locations. Multiple locations may be involved.

In the above embodiment, the operator at the control location is a medical specialist. The invention is not limited to the medical domain. Guidance of remote assistants by specialists could be carried out in many other domains utilising the present invention. For example, it could equally be applied to remote instruction of maintenance engineers, defence staff, border security. It is applicable anywhere where an expert opinion may be required or anywhere where remote indication may be required.

In an embodiment, the first and second location is divided into individual zones with each zone serviced by at least one individual camera and display arrangement. The zones, once divided within each location is then in communication with the corresponding zone in the remote location. This arrangement allows a user to place focus on a specific zone during the teleconference and is particularly useful in situations where the user may be required to interview or examine a specific person. In these instances, by directing the examination procedure to a specific zone, the user will appear on the corresponding remote display as focusing only on a specific area, and thereby enhancing the teleconference experience. In examples such as medical applications, a specialist examining a patient in an examination zone will be able to maintain eye contact with the patient since the camera and display arrangement in the zone ensures both the specialist and the patient can focus only on the specialist or patient. In the above embodiment, the specialist's office and the clinic room are each divided into a consultation zone arranged for the specialist to consult with the patient, an examination zone for examining the patient and a general zone arranged for the specialist to see and communicate with every person in the clinic room.

While specific embodiments of the guidance system and components therefore have been described it should be appreciated that the guidance system can be embodied in many other forms.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An apparatus for providing remote indication comprising a projection arrangement arranged to project an indicator onto an object at a first location, and a control arrangement enabling control of projection of the indicator from a second location remote from the first location.

2. An apparatus in accordance with claim 1, further comprising a tracking arrangement arranged to control projection of the indicator to track motion of the object, whereby the indicator remains projected onto the object as the object moves.

3. An apparatus in accordance with claim 2, wherein the tracking arrangement is arranged to follow any translation and/or rotations of the object and control projection of the indicator to match any translation or rotation of the object.

4. An apparatus in accordance with claim 2 or claim 3, wherein a marker is associated with the object and the tracking arrangement is arranged to utilise motion of the marker to control projection of the indicator.

5. An apparatus in accordance with any one of the preceding claims, wherein the control arrangement is arranged to control the projector arrangement such that the indicator is an artefact.

6. An apparatus in accordance with claim 5, wherein the artefact is one or more of a drawing, graphic, pattern, annotation or animation.

7. An apparatus in accordance with claim 6, wherein the artefact is arranged to provide information to a user.

8. An apparatus in accordance with any one of the preceding claims, further comprising a teleconference system, whereby a teleconference may take place between the first location and the second location.

9. An apparatus in accordance with claim 8, the teleconference system comprising at least one video display and one camera at each of the first and second locations, and wherein a furniture arrangement is provided at each of the first and second locations, the furniture arrangements, video cameras and video displays being arranged so that the first location appears as a complementary arrangement to the second location.

10. An apparatus in accordance with claim 9, wherein the furniture arrangement includes a desk or table arrangement at the first location and a desk or table arrangement at the second location, being arranged together with the video cameras and video displays such that it appears to persons viewing across the teleconference link that the desk or table arrangement is a single “virtual” desk or table arrangement that the persons at the first and second locations are seated about.

11. An apparatus in accordance with any one of claims 8 to 10, wherein the first and second location are divided into teleconference zones arranged to conduct teleconferencing between the first and second location.

12. An apparatus in accordance with claim 11 wherein each teleconference zone in the first location is arranged to communicate with a corresponding zone of the second location.

13. An apparatus in accordance with any one of the preceding claims, further comprising a remote actuator at the first location, and an actuator controller arranged to enable control of the remote actuator from the second location.

14. An apparatus in accordance with claim 13, wherein the remote actuator is arranged to be mounted to or worn by a person at the first location.

15. An apparatus in accordance with claim 14, wherein remote actuator is a vibro-tactile actuator arranged to provide a physical “nudge” or “tap” to the person to which the remote actuator is mounted or worn.

16. An apparatus in accordance with claim 15, wherein the remote actuator is mounted by a wrist band.

17. An apparatus in accordance with claim 15, wherein the remote actuator is mounted by a glove.

18. A method for providing remote indication comprising a step of projecting an indicator onto an object at a first location, and a step of controlling the projection of the indicator from a second location remote from the first location.

19. A method in accordance with claim 18, further comprising a step of tracking motion of the object and projecting the indicator to remain in position on the object during the motion.

20. A method in accordance with claim 19, wherein the step of tracking motion of the object follows any translations and/or rotations of the object and controls projection of the indicator to match any translations or rotations of the object.

21. A method in accordance with claim 19 or 20, further comprising a step of associating a marker with the object, and wherein the step of tracking motion of the object utilises motion of the marker to control projection of the indicator.

22. A method in accordance to any one of claims 18 to 21, wherein the step of projecting the indicator comprises a step of projecting an artefact.

23. A method in accordance with claim 22, wherein the artefact is one or more of an annotation, drawing, pattern, animation, graphic or any artefact.

24. A method in accordance with claim 23, wherein the artefact is arranged to provide information to a user.

25. A method in accordance with any one of claims 18 to 24, further comprising a step of teleconferencing between the first location and the second location.

26. A method in accordance with claim 25, wherein the step of teleconferencing comprises arranging at least one video display, a camera and furniture at the first and second location such that the first location appears as a complementary arrangement to the second location.

27. A method in accordance with accordance claim 26, wherein the furniture includes a desk or table arrangement a the first location and a desk or table arrangement at the second location, and the step of arranging comprises arranging the furniture arrangement together with the video cameras and video displays such that it appears to persons viewing across the teleconference link that the desk or table arrangement is a single “virtual” desk or table arrangement that the persons at the first and second locations are seated about.

28. A method in accordance with any one of claims 18 to 27, wherein the first and second location are divided into teleconference zones arranged to conduct teleconferencing between the first and second location.

29. A method in accordance with claim 28, wherein each teleconference zone in the first location is arranged to communicate with a corresponding zone of the second location.

30. A method in accordance with any one of claims 18 to 29, further comprising a step of controlling a remote actuator at the first location from the second location.

31. A method in accordance with claim 30, wherein the remote actuator is controlled by an actuator controller located at the second location.

32. A method in accordance with claim 31, wherein the remote actuator is a vibro-tactile actuator arranged to provide a physical “nudge” or “tap” to the person to which the remote actuator is mounted or worn.

33. A method in accordance with claim 32, wherein the remote actuator is mounted by a wrist band.

34. A method in accordance with claim 33, wherein the remote actuator is mounted by a glove.

35. A teleconference system comprising at least one video display and one camera at each of a first and second location, and a furniture arrangement provided at each of the first and second locations, the furniture arrangements, video cameras and video displays being arranged so that the first location appears as a complementary arrangement to the second location.

36. A teleconference system comprising at least one video display and one camera at the first and second locations, a remote actuator at the first location and an actuator control arranged to enable control of the remote actuator from the second location.

37. A method of teleconferencing between a first location and a second location, comprising the steps of arranging at least one video display, a camera and furniture at the first and second locations such that the first location appears as a complementary arrangement to the second location.

38. A method of teleconferencing, comprising the step of controlling a remote actuator at a first location, from a second location, in order to guide an assistant at the second location.
